(19) United States
(12) Patent Application Publication
(10) Pub. No.: US 2013/0128574 A1
(43) Pub. Date: May 23, 2013

(54) Electric Shock Resistant L.E.D. Based Light

(71) Applicant: ILUMISYS, INC., Troy, MI (US)

(72) Inventors: John Ivey, Farmington Hills, MI (US); Dennis Siemiet, Rochester Hills, MI (US)

(73) Assignee: ILUMISYS, INC., Troy, MI (US)

(21) Appl. No.: 13/742,678

(22) Filed: Jan. 16, 2013

Related U.S. Application Data
(63) Continuation of application No. 12/126,579, filed on May 23, 2008, now Pat. No. 8,360,599.

(51) Int. Cl. F21V 29/00; F21V 23/06

(52) U.S. Cl. CPC F21V 29/22; F21V 23/06
USPC 362/235; 362/249.02

(57) ABSTRACT

An LED-based light comprises: a tubular housing formed of a high-dielectric material and defined at least in part by a light transmitting portion; an elongate circuit board disposed within the housing; at least one LED mounted on the circuit board; an elongate heat sink disposed within the housing, the heat sink having an interior circuit board mounting surface opposing a radially outer surface, the circuit board mounted in thermally conductive relation to the circuit board mounting surface, substantially all of the radially outer surface of the heat sink in thermally conductive relation with the tubular housing for electrically insulated thermal transmission of heat generated by the LED from the circuit board to an ambient environment surrounding the LED-based light; and a pair of end caps disposed on opposing ends of the housing with connectors configured to physically connect the LED-based light to a conventional fluorescent light fixture.

### CROSS REFERENCE TO RELATED APPLICATIONS

This application is a continuation of pending U.S. patent application Ser. No. 12/126,579 filed on May 23, 2008.

### TECHNICAL FIELD

The present invention relates to a light emitting diode (LED) based light for replacing a conventional fluorescent light in a fluorescent light fixture.

### BACKGROUND

Fluorescent tube lights are widely used in a variety of locations, such as schools and office buildings. Although conventional fluorescent bulbs have certain advantages over, for example, incandescent lights, they also pose certain disadvantages including, inter alia, disposal problems due to the presence of toxic materials within the glass tube.

LED-based tube lights which can be used as one-for-one replacements for fluorescent tube lights having appeared in recent years. One such LED-based fluorescent replacement light includes LEDs mounted on an elongated circuit board in a semi-cylindrical metal housing which also serves as a heat sink for the LEDs. A U-shaped lens snaps onto the heat sink to cover the LEDs and disperse light from them.

### BRIEF SUMMARY

The inventors have discovered that the LED-based fluorescent tube replacement lights with exposed metal heat sinks as described above can present a shock hazard during installation. Ballasts in some fluorescent fixtures provide up to 1000 V at 40 kHz and higher to generate the initial striking voltage necessary for starting a conventional fluorescent light. If during installation of the LED-based light one end of the LED-based light is plugged into the fluorescent fixture while power is being provided to the fixture, the ballast may detect the incomplete circuit and provide the high-frequency starting voltage designed for starting a fluorescent light to the LED-based light. The high-frequency starting voltage provided by the ballast causes a high voltage across the circuit board in the LED-based light. Because the heat sink in the LED-based light is positioned closely to the circuit board, the high-frequency starting voltage can cause parasitic capacitive coupling between the circuit board and the heat sink, thereby producing a charge in the heat sink. A person installing the LED-based light is often touching the metal heat sink, providing a ground for the charge to pass through and resulting in a significant electrical shock to the person.

The present invention eliminates the shock hazard potential present in LED-based lights of the type having exposed metal heat sinks while still providing sufficient thermal management of heat produced by the LEDs.

In one aspect, an LED-based light for replacing a conventional fluorescent light bulb in a fluorescent light fixture comprises: a tubular housing formed of a high-dielectric material and defined at least in part by a light transmitting portion; an elongate circuit board disposed within the housing; at least one LED mounted on the circuit board; an elongate heat sink disposed within the housing, the heat sink having an interior circuit board mounting surface opposing a radially outer surface, the circuit board mounted in thermally conductive relation to the circuit board mounting surface, substantially all of the radially outer surface of the heat sink in thermally conductive relation with the tubular housing for electrically insulated thermal transmission of heat generated by the at least one LED from the circuit board to an ambient environment surrounding the LED-based light; and a pair of end caps disposed on opposing ends of the housing, each end cap including at least one connector configured to physically connect the LED-based light to a conventional fluorescent light fixture.

In another aspect, an LED-based light for replacing a conventional fluorescent tube in a conventional fluorescent light fixture comprises: a tubular housing formed of a high-dielectric material, the housing having a substantially continuous circular cross section and defined at least in part by a light transmitting portion; an elongate circuit board disposed within the housing; at least one LED mounted on the circuit board; an elongate heat sink disposed within the housing, the heat sink having an interior circuit board mounting surface opposing a radially outer surface, the circuit board mounted in thermally conductive relation to the circuit board mounting surface, the housing contoured to the radially outer surface and attached in thermally conductive relation to the radially outer surface to directly isolate the radially outer surface from an ambient environment exterior of the housing from a charge occurring in the heat sink as a result of parasitic capacitive coupling between the heat sink and the circuit board resulting from a high-frequency starting voltage designed for starting a conventional fluorescent tube being applied across the circuit board while transmitting heat from the radially outer surface to the ambient environment; a light diffusing lens positioned between the at least one LED and the light transmitting portion; and a pair of end caps disposed on opposing ends of the housing, each end cap including at least one connector configured to physically connect the LED-based light to a conventional fluorescent light fixture.

In another aspect, an LED-based light for replacing a conventional fluorescent light bulb in a fluorescent light fixture comprises: a tubular housing formed of an electrically insulating material and defined at least in part by a light transmitting portion; an elongate circuit board disposed within the housing; a plurality of LEDs mounted along a length of the circuit board for emitting light through the light transmitting portion; an elongate heat sink disposed within the housing, the heat sink having a circuit board mounting surface opposing a radially outer surface, the circuit board mounted in thermally conductive relation to the circuit board mounting surface, the housing contoured to the radially outer surface and engaged in thermally conductive relation therewith for electrically insulated thermal transmission of heat generated by the plurality of LEDs from the circuit board to an ambient environment surrounding the LED-based light; and a pair of end caps disposed on opposing ends of the housing, each end cap including at least one connector configured to physically connect the LED-based light to a conventional fluorescent light fixture.

These and other aspects will be described in additional detail below.

### BRIEF DESCRIPTION OF THE DRAWINGS

The description herein makes reference to the accompanying drawings wherein like reference numerals refer to like parts throughout the several views, and wherein:

FIG. 1 is a perspective view of a LED-based replacement light in accordance with the invention and a fluorescent fixture;

FIG. 2 is a cross-section view of the LED-based replacement light of FIG. 1 at a position similar to line A-A;

FIG. 3 is a cross-section view of another LED-based replacement light in accordance with the invention along a line similar to line A-A in FIG. 1;

FIG. 4 is a cross-section view of the LED-based replacement light of FIG. 3 along line B-B;

FIG. 5 is a cross-section view of another LED-based replacement light in accordance with the invention along a line similar to line B-B in FIG. 3;

FIG. 6 is a perspective view of another LED-based replacement light with an exposed heat sink in accordance with the invention;

FIG. 7 is a cross-section view of the LED-based replacement light of FIG. 6 along line C-C;

FIG. 8 is a cross-section view of another LED-based replacement light in accordance with the present invention along a line similar to line C-C in FIG. 6;

FIG. 9 is an exploded view of another LED-based replacement light in accordance with the present invention;

FIG. 10 is a cross-section view of the LED-based replacement light of FIG. 9 along a line similar to line C-C in FIG. 6; and

FIG. 11 is a cross-section view of another LED-based replacement light in accordance with the present invention along a line similar to line C-C in FIG. 6.

### DETAILED DESCRIPTION OF EMBODIMENTS OF THE INVENTION

FIGS. 1-11 illustrate LED-based replacement lights 10 according to the present invention for replacing a conventional fluorescent light bulb in a fluorescent fixture 12. The lights 10 each include a circuit board 14, multiple LEDs 16, a tubular housing at least partially defined by a high-dielectric translucent portion, and bi-pin electrical connectors 22 affixed to plastic end caps 23.

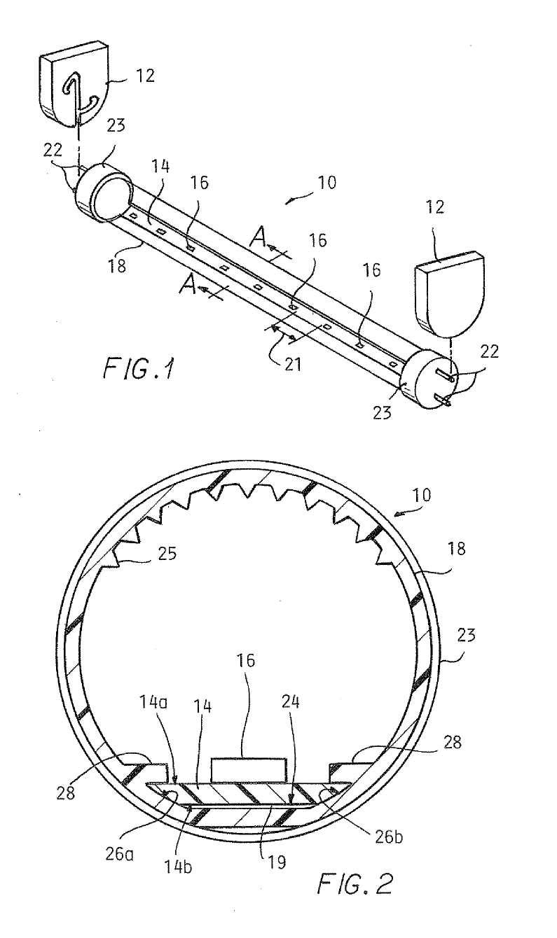

FIGS. 1 and 2 show an illustrative embodiment of the present invention in which the tubular housing consists of a tube 18. The circuit board 14 has a LED-mounting side 14a and a primary heat transferring side 14b opposite the LED-mounting side 14a. The circuit board 14 may be made in one piece or in longitudinal sections joined by electrical bridge connectors. The circuit board 14 and the tube 18 are in thermally conductive relation with the circuit board 14 attached to the tube 18 using highly thermally conductive adhesive transfer tape 19. The circuit board 14 can alternatively be positioned in a thermally conductive relation with the tube 18 by attaching the circuit board 14 to the tube 18 using screws, glue, a friction fit, and other attachments known to those of skill, in which cases thermal grease can be applied between the circuit board 14 and tube 18. The circuit board 14 is preferably one on which metalized conductor patterns can be formed in a process called “printing” to provide electrical connections from the connectors 22 to the LEDs 16 and between the LEDs 16 themselves. An insulative board is typical, but other circuit board types, e.g., metal core circuit boards, can alternatively be used.

The LEDs 16 are mounted at predetermined intervals 21 along the length of the circuit board 14 to uniformly emit light through a portion the tube 18. Although the LEDs 16 are shown as high-power surface-mount devices of a type available from Nichia, other types can be used. The term “high-power” means LEDs 16 with power ratings of 0.25 watts or more. Preferably, the LEDs 16 have power ratings of one watt or more. Also, although surface-mounted LEDs 16 are shown, one or more organic LEDs can be used in place of or in addition thereto.

The spacing 21 between LEDs 16 along the circuit board 14 is a function of the length of the tube 18, the amount of light desired, the wattage of the LEDs 16, and the viewing angle of the LEDs 16. For a 48″ light 10, the number of LEDs 16 may vary from about thirty to sixty such that the light 10 outputs approximately 3,000 lumens, and the spacing 21 between the LEDs 16 varies accordingly. The arrangement of LEDs 16 on the circuit board 14 is such as to substantially fill the entire space between the end caps 23.

Still referring to FIGS. 1 and 2, the tube 18 includes a longitudinally extending flat interior surface 24 for supporting the circuit board 14. The surfaces 26a and 26b of the tube 18 on either side of the circuit board 14 are optionally contoured to the sides of the circuit board 14. The exterior of the tube 18 can optionally be D-shaped, with the exterior flat portion corresponding to the location of the flat interior surface 24. The tube 18 can be formed of polycarbonate, acrylic, glass, or another high-dielectric light transmitting material. As used herein, the term “high-dielectric” means a material which has a low conductivity to direct current; e.g., an insulator.

The tube 18 includes optional tabs 28 for securing the circuit board 14. The tabs 28 project from the tube 18 on opposite sides of the circuit board 14 and contact the LED-mounting side 14a of the circuit board 14. The tabs 28 are preferably formed integrally with the tube 18 by, for example, extruding the tube 18 to include the tabs 28. Each tab 28 can extend the entire length of the tube 18, though a series of discrete tabs 28 can alternatively be used to secure the circuit board 14.

The light 10 can include features for uniformly distributing light to the environment to be illuminated in order to replicate the uniform light distribution of a conventional fluorescent bulbs the light 10 is intended to replace. As described above, the spacing 21 of the LEDs 16 can be designed for uniform light distribution. Additionally, the tube 18 can include light diffracting structures, such as the illustrated longitudinally extending ridges 25 formed on the interior of the tube 18. Alternatively, light diffracting structures can include dots, bumps, dimples, and other uneven surfaces formed on the interior or exterior of the tube 18. The light diffracting structures can be formed integrally with the tube 18, for example, by molding or extruding, or the structures can be formed in a separate manufacturing step such as surface roughening. The light diffracting structures can be placed around an entire circumference of the tube 18, or the structures can be placed along an arc of the tube 18 through which a majority of light passes. In addition or alternative to the light diffracting structures, a light diffracting film can be applied to the exterior of the tube 18 or placed in the tube 18, or the material from which the tube 18 is formed can include light diffusing particles.

Alternatively to the tube 18 illustrated in FIGS. 1 and 2, the tube 18 can be made from a dielectric light transmitting lens portion extending at least a length and arc of the housing 18 through which the LEDs 16 emit light and a dielectric dark body portion attached to the light transmitting portion and in thermally conductive relation with the circuit board 14. Due to its dark color, the dark body portion dissipates a greater amount of heat to the ambient environment than a lighter colored body.

End caps 23 carrying bi-pin connectors 22 are attached to each longitudinal end of the tube 18 for physical and electrical connection of the light 10 to the fixture 12. Since the LEDs 16 in the present embodiment are directionally oriented, the light 10 should be installed at a proper orientation relative to a space to be illuminated to achieve a desired illumination effect. Bi-pin connectors 22 allow only two light 10 installation orientations, thereby aiding proper orientation of the light 10. While the end caps 22 are shown as cup-shaped structures that slide over longitudinal ends of the tube 18, alternative end caps that fit into the tube 18 can be used in place of the illustrated cup-shaped end caps 22. Also, only two of the four illustrated pins 22 must be active; two of the pins 22 can be “dummy pins” for physical but not electrical connection to the fixture 12. Bi-pin connectors 22 are compatible with many fluorescent fixtures 12, though end caps 23 with alternative electrical connectors, e.g., single pin end caps, can be used in place of end caps 22 carrying bi-pin connectors 23 when desired.

Positioning the circuit board 14 in thermally conductive relation with the tube 18 provides sufficient heat dissipation for the LEDs 16 to function well. In most heat transfer applications, the factor limiting the heat dissipating ability of a structure is the thermal resistance of an air film at the outer surface of the structure, necessitating the use of a highly thermally conductive metal exposed to the ambient environment in order to sufficiently dissipate heat. However, the tube 18 has such a large external surface area that the factor limiting the ability of the light 10 to dissipate heat is conduction from the LEDs 16 to the exterior of the tube 18. Positioning the primary heat transferring side 14b of the circuit board 14 in thermally conductive relation with the tube 18 provides sufficient heat conduction from the LEDs 16 to the exterior of the tube 18 for operation of the LEDs 16 even when the tube 18 is not constructed from a highly thermally conductive material. As a result, the tube 18 can be constructed from a low thermally conductive material.

The ability to use a low thermally conductive material for the tube 18 eliminates the shock hazard associated with capacitive coupling between the circuit board and heat sink of conventional LED-based replacement lights. Polycarbonate, acrylic, glass, and most other low thermally conductive materials from which the tube 18 can be constructed are also high-dielectric materials. Since the tube 18 in the present embodiment provides sufficient heat dissipation despite being constructed from a high-dielectric material, the light 10 need not include a highly thermally conductive structure positioned close to the circuit board 14 for dissipating heat. Thus, the light 10 as illustrated in FIGS. 1 and 2 need not include a highly electrically conductive heat sink that can be charged to a sufficient level as a result capacitive coupling to shock a person handling the light 10.

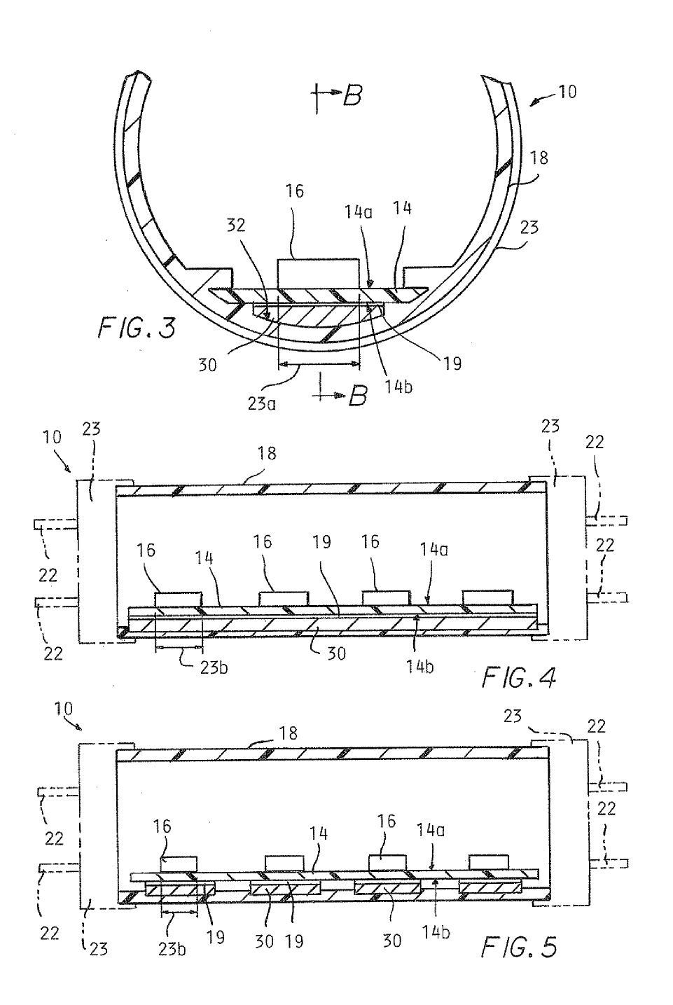

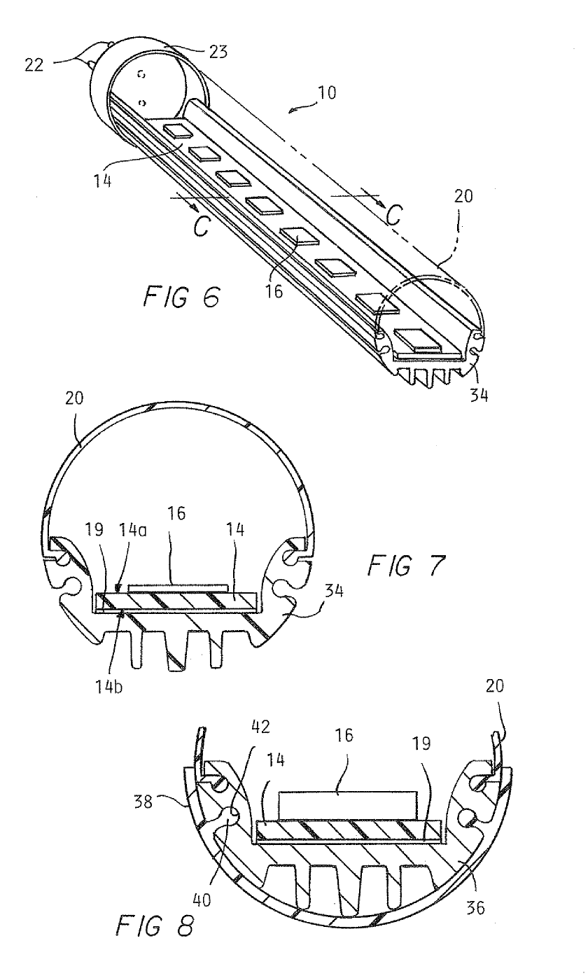

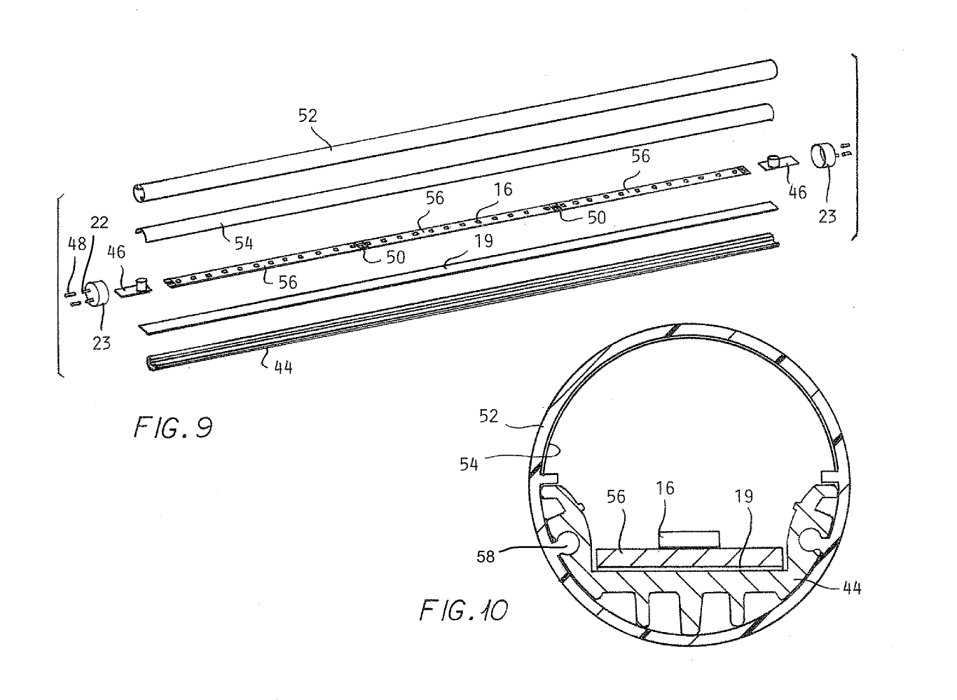

FIGS. 3-5 show additional illustrative embodiments of a LED-based light 10 according to the present invention. The embodiments of the light 10 in FIGS. 3-5 are identical to the embodiment illustrated in FIGS. 1 and 2, except the lights 10 in FIGS. 3-5 includes a highly-thermally conductive heat spreader 30 in thermally conductive relation with both the primary heat transferring side 14b of the circuit board 14 and an interior surface 32 of the tube 18. The thermally conductive relation between the circuit board 14 and the heat spreader 30 is achieved using thermally conductive adhesive transfer tape 19 for attaching the circuit board 14 to the heat spreader 30 as shown in FIGS. 3-5, though the circuit board 14 can alternatively be attached to the heat spreader 30 using screws, glue, a friction fit, and other attachments known to those of skill, in which cases thermal grease can be applied between the circuit board 14 and heat spreader 30. The heat spreader 30 can be a continuous mass extending the length of the circuit board 14 as illustrated in FIG. 4, or multiple discrete heat spreaders 30 can be placed between areas 23 (each area 23 is the product of a width 23a as shown in FIG. 3 and a length 23b as shown in FIGS. 4 and 5) of the circuit board 14 directly underlying the LEDs 16 as illustrated in FIG. 5.

The use of a heat spreader 30 increases the thermal efficiency of the light 10 by spreading heat produced by the LEDs 16 out over a greater area of the tube 18 relative to the transferring heat directly from the circuit board 14 to the tube 18. Additionally, even though the heat spreader 30 can be formed of aluminum or another highly thermally conductive material that is also highly electrically conductive, the lights 10 of the embodiments in FIGS. 3-5 eliminate the shock hazard potential because the heat spreader 30 is enclosed by the high-dielectric tube 18. The thickness of the tube 18 is a factor of dielectric properties of the tube 18 material, the amount the heat spreader 30 can be expected to become charged due to capacitive coupling, and the amount of charge that can safely be transmitted to a person handling the light 10.

FIGS. 6 and 7 show another illustrative embodiment of the present invention in which the tubular housing of the LED-based replacement light 10 is formed by engaging a high-dielectric translucent lens 20 with a highly thermally conductive, high-dielectric heat sink 34. The circuit board 14 is mounted in thermally conductive relation with the heat sink 34 by attaching the circuit board 14 to the heat sink 34 using highly thermally conductive adhesive transfer tape 19, though the circuit board 14 can also be mounted to the heat sink 34 using screws, glue, a friction fit, and other attachment methods known to those of skill in the art to achieve the desired thermally conductive relation, in which cases thermal grease can be applied between the circuit board 14 and heat sink 34.

The lens 20 can be made from polycarbonate, acrylic, glass, or another high-dielectric light transmitting material. The lens 20 can include light diffracting structures, such as the longitudinally extending ridges 25 included in the tube 18 of FIG. 2. Alternatively, light diffracting structures can include dots, bumps, dimples, and other uneven surfaces formed on the interior or exterior of the lens 20. A light diffracting film can be applied to the exterior of the lens 20 or placed between the lens 20 and heat sink 34. The lens 20 can be formed of a material including light diffusing particles. The term “lens” as used herein means a light transmitting structure, and not necessarily a structure for concentrating or diverging light.

The lens 20 and heat sink 34 can be engaged such a large surface area of the heat sink 34 is exposed to the ambient environment. For example, the engagement between the lens 20 and heat sink 34 can be as described in U.S. application Ser. No. 12/040,901, which is hereby incorporated by reference in its entirety. Alternatively, glue, screws, tape, a snap or friction fit, or other means known to those of skill in the art can be used to engage the lens 20 with the heat sink 34.

Since the heat sink 34 is arranged in close proximity to the circuit board 14 and exposed to the ambient environment, the heat sink 34 is made from a high-dielectric material to eliminate the shock hazard potential. Moreover, it is desirable that the heat sink 34 be made from a material that is highly thermally conductive in addition to being a high-dielectric, such as a D-Series material by Cool Polymers of Warwick, Rhode Island. The use of a highly thermally conductive, high-dielectric material allows the heat sink 34 to efficiently transfer heat to the ambient environment. To aid in heat dissipation, the heat sink 34 can include fins for increasing its surface area and heat dissipating ability. Since the heat sink 34 is highly dielectric, the light 10 can be installed one end at a time while power is being applied without becoming charged to a large enough degree to present a shock hazard to the installer.

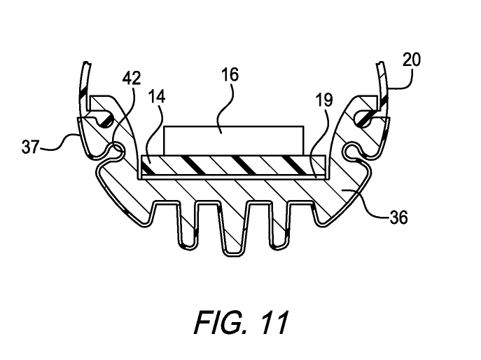

FIG. 8 is another illustrative embodiment including a heat sink 36 engaged with the lens 20. The heat sink 36 can be made from a material that is highly thermally conductive and highly electrically conductive, such as aluminum. A high-dielectric heat sink cover 38 overlays the heat sink 36 forming an exterior portion of the tubular housing. The heat sink cover 38 attaches to the heat sink 36 by slidably engaging rounded-end projections 40 formed in the cover 38 with grooves 42 formed in the heat sink 36. Alternative forms of attachment, such as screws, highly thermally conductive adhesive tape, friction fit and other attachments known to those of skill in the art are alternatively usable. Also, the cover 38 can be shaped to the contours of the heat sink 36. For example, the heat sink 36 can be coated or wrapped with a high-dielectric material. An example coating 37 is shown in FIG. 11. FIG. 11 is similar to the embodiment shown in FIG. 8. The thickness of the cover 38 is a factor of dielectric properties of the cover's 38 material, the amount the heat sink 36 can be expected to become charged due to capacitive coupling, and the amount of charge that can safely be transmitted to a person handling the light 10.

The heat sink cover 38 is preferably made of a high-dielectric and highly thermally conductive material, such as a D-Series material by Cool Polymers of Warwick, R.I., though the heat sink cover 38 need not necessarily be highly thermally conductive. With the heat sink cover 38 attached to the heat sink 36, a radially outer portion of the tubular housing consisting of the lens 20 and the cover 38 is formed of high-dielectric materials, thereby eliminating a shock hazard potential resulting from capacitive coupling of the circuit board 14 and heat sink 36.

FIG. 9 illustrates another embodiment of the present invention. A cylindrical high-dielectric cover 52 circumscribes a heat sink 44 and an optional bi-axially diffusing lens 54. The cylindrical cover 52 can be an approximately 0.002″ thick tube of clear polycarbonate, acrylic, glass, or other high-dielectric transparent materials known to those of skill in the art. The thickness of the cover 52 can vary depending on the dielectric properties of the material from which the cover 52 is made and the expected amount of charge on the heat sink 44 in the event of capacitive coupling. Also, the thickness of the cover 52 can be designed such that the cover 52 provides structural support for the light 10, if desired. The cover 52 can include integral tabs 58 extending longitudinally, and the cover 52 can be formed by, for example, extrusion. The tabs 58 allow the heat sink 44 to be securely slidably engaged with the cover 52 Likewise, the bi-axially diffusing lens 54 can be slidably engaged on the opposing side of the tabs 58 from the heat sink 44. Alternatively, the cover 52 can be a high-dielectric layer wrapped around the heat sink 44 and lens 54.

The optional bi-axially diffusing lens 54 preferably provides approximately 15° of diffraction to approximate the appearance of a conventional fluorescent tube. Instead of a separate lens 54, other diffractive structure can be used. For example, the cover 52 can optionally include light diffracting structures, such as ridges 25, described above in relation to the tube 18. If desired, the light 10 need not include the lens 54 or any other diffractive structures.

A circuit board structure carrying high-power LEDs 16 includes multiple circuit boards 56 attached by electrical bridge connectors 50. Alternatively, the circuit board structure can include a single circuit board or other electric circuitry. The circuit board structure is attached to the heat sink 44 using highly thermally conductive adhesive transfer tape 19. The circuit board structure can alternatively be attached with screws, glue, a friction fit, and other attachments known to those of skill, in which cases thermal grease can be applied between the circuit board structure and the heat sink 44. End caps 23 carrying bi-pin connectors 22 can be slidably engaged over the ends of the cover 52, with screws 48 securing the ends caps 23 to the heat sink 44. Alternative end caps can be used as described above. Electrical components 46 can be attached to the circuit board structure in electrical communication between the pins 22 and the LEDs 16 for manipulation of the current provided by the socket 12 as necessary.

Providing the cover 52 allows the use of a highly thermally and electrically conductive heat sink 44, e.g., an extruded aluminum heat sink, because the dielectric properties of the cover 52 reduce the shock hazard potential of capacitive coupling between the circuit board structure and the heat sink 44. Additionally, the cover 52 can provide structural support.

The above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. An LED-based light for replacing a conventional fluorescent light bulb in a fluorescent light fixture, the LED-based light comprising:
a tubular housing formed of a high-dielectric material and defined at least in part by a light transmitting portion;
an elongate circuit board disposed within the housing;
at least one LED mounted on the circuit board;
an elongate heat sink disposed within the housing, the heat sink having a circuit board mounting surface opposing a radially outer surface, the circuit board mounted in thermally conductive relation to the circuit board mounting surface, substantially all of the radially outer surface of the heat sink in thermally conductive relation with the tubular housing for electrically insulated thermal transmission of heat generated by the at least one LED from the circuit board to an ambient environment surrounding the LED-based light; and
a pair of end caps disposed on opposing ends of the housing, each end cap including at least one connector configured to physically connect the LED-based light to the fluorescent light fixture.

2. The LED-based light of claim 1, wherein the housing is configured to isolate the radially outer surface of the heat sink from the ambient environment surrounding the LED-based light from a charge occurring in the heat sink as a result of parasitic capacitive coupling between the heat sink and the circuit board resulting from a high-frequency starting voltage designed for starting a conventional fluorescent tube being applied across the circuit board.

3. The LED-based light of claim 1, wherein the housing has a substantially continuous circular cross section along a length of the housing.

4. The LED-based light of claim 1, wherein a plurality of LEDs are mounted along a length of the circuit board at predetermined intervals for uniformly emitting light through the light transmitting portion.

5. The LED-based light of claim 1, further comprising:
a lens positioned between the at least one LED and the light transmitting portion.

6. The LED-based light of claim 5, wherein the lens is configured to diffuse a light generated by the at least one LED.

7. The LED-based light of claim 1, wherein the heat sink is composed of an electrically conductive material.

8. The LED-based light of claim 1, wherein at least a portion of the housing that is in the thermally conductive relation with the radially outer surface of the heat sink is composed of a low thermally conductive material.

9. The LED-based light of claim 1, wherein the housing is composed of one of a polycarbonate, acrylic or glass material.

10. The LED-based light of claim 1, wherein the housing includes at least one projection having a rounded end on an interior portion thereof and the radially outer portion of the heat sink includes at least one corresponding groove configured to engage the projection to attach the heat sink to the housing.

11. The LED-based light of claim 1, wherein the at least one connector is further configured to electrically connect the at least one LED to a conventional fluorescent light fixture.

12. The LED-based light of claim 1, wherein the at least one connector is a bi-pin connector.

13. An LED-based light for replacing a conventional fluorescent tube in a conventional fluorescent light fixture, the LED-based light comprising:
a tubular housing formed of a high-dielectric material, the housing having a substantially continuous circular cross section and defined at least in part by a light transmitting portion;
an elongate circuit board disposed within the housing;
at least one LED mounted on the circuit board;
an elongate heat sink disposed within the housing, the heat sink having a circuit board mounting surface opposing a radially outer surface, the circuit board mounted in thermally conductive relation to the circuit board mounting surface, the housing contoured to the radially outer surface and attached in thermally conductive relation to the radially outer surface to isolate the radially outer surface from an ambient environment exterior of the housing from a charge occurring in the heat sink as a result of parasitic capacitive coupling between the heat sink and the circuit board resulting from a high-frequency starting voltage designed for starting a conventional fluorescent tube being applied across the circuit board while transmitting heat from the radially outer surface to the ambient environment;
a light diffusing lens positioned between the at least one LED and the light transmitting portion; and
a pair of end caps disposed on opposing ends of the housing, each end cap including at least one connector configured to physically connect the LED-based light to the fluorescent light fixture.

14. The LED-based light of claim 13, wherein a plurality of LEDs are mounted along a length of the circuit board at predetermined intervals for uniformly emitting light through the light transmitting portion.

15. The LED-based light of claim 13, wherein the heat sink is composed of an electrically conductive material.

16. The LED-based light of claim 13, wherein a portion of the housing that is in the thermally conductive relation with the radially outer surface of the heat sink is composed of a low thermally conductive material.

17. The LED-based light of claim 13, wherein the housing is composed of one of a polycarbonate, acrylic or glass material.

18. The LED-based light of claim 13, wherein the housing includes at least one projection having a rounded end on an interior portion thereof and the radially outer portion of the heat sink includes at least one corresponding groove configured to engage the projection to attach the heat sink to the housing.

19. The LED-based light of claim 13, wherein the at least one connector is a bi-pin connector further configured to electrically connect the at least one LED to a conventional fluorescent light fixture.

20. An LED-based light for replacing a conventional fluorescent light bulb in a fluorescent light fixture, the LED-based light comprising:
a tubular housing formed of an electrically insulating material and defined at least in part by a light transmitting portion;
an elongate circuit board disposed within the housing;
a plurality of LEDs mounted along a length of the circuit board for emitting light through the light transmitting portion;
an elongate heat sink disposed within the housing, the heat sink having a circuit board mounting surface opposing a radially outer surface, the circuit board mounted in thermally conductive relation to the circuit board mounting surface, the housing contoured to the radially outer surface and engaged in thermally conductive relation therewith for electrically insulated thermal transmission of heat generated by the plurality of LEDs from the circuit board to an ambient environment surrounding the LED-based light; and
a pair of end caps disposed on opposing ends of the housing, each end cap including at least one connector configured to physically connect the LED-based light to a conventional fluorescent light fixture.
